(19) United States
(12) Patent Application Publication
(10) Pub. No.: US 2026/0148120 A1
(43) Pub. Date: May 28, 2026

(54) USING LARGE LANGUAGE MODELS FOR INTERPRETABLE FEATURE ENGINEERING

(71) Applicant: SAP SE, Walldorf (DE)

(72) Inventors: Mohamed BOUADI, La Garenne-Colombes (FR); Arta ALAVI, Andresy (FR); Salima BENBERNOU, Colombes (FR); Mourad OUZIRI, Gennevilliers (FR)

(21) Appl. No.: 18/956,875

(22) Filed: Nov. 22, 2024

(51) Int. Cl. G06N 20/00

(52) U.S. Cl. CPC G06N 20/00

(57) ABSTRACT

Systems and methods include reception of a dataset comprising a plurality of features, prompting of each of a plurality of text generation models to generate code to create one or more features based on the dataset, execution of the code generated by each of the plurality of text generation models on the dataset to create a first set of candidate features, discarding of non-interpretable features of the first set of candidate features to create a second set of candidate features, determination of a performance of a machine learning model trained using the second set of candidate features, and determination to add the second set of candidate features to the dataset based on the determined performance.

### BACKGROUND

Organizations have long employed computing systems to manage and store operational data. The volume of such data has grown exponentially over time, resulting in continuous development of new and more-efficient systems for handling such data. Systems to facilitate understanding and analysis of large data sets have similarly evolved.

Over the past decade, organizations have increasingly used modeling applications to predict future events based on stored data. These applications have been used to solve difficult problems and uncover new opportunities across a variety of domains. A modeling application typically provides tools for defining and training a machine learning (ML) algorithm which infers a desired output based on specified known inputs.

Unfortunately, defining and training an ML algorithm using existing tools is quite difficult for non-experts in the field. Generally, it is required to gather suitable training data, define model inputs (i.e., perform feature selection) from the training data, select a model architecture, train the model, and deploy the model. Each of the foregoing steps is replete with corresponding decisions and uncertainties.

For example, the goal of feature selection is to select features which result in an efficient and accurate ML algorithm. The performance of a particular set of features may be validated by prior knowledge or by tests using synthetic and/or actual data sets. However, selecting an optimal set of features presents an intractable computational problem.

In particular, the number of possible features that can be constructed is unlimited. Moreover, transformations can be composed and applied recursively to the features generated by previous transformations. In order to confirm whether a newly-composed feature is relevant, a new model including the feature is trained and evaluated. This validation is costly and impractical to perform for each newly-constructed feature.

In view of the foregoing, feature selection is primarily performed manually by a data scientist. The data scientist uses intuition, a background in data mining and statistics, and domain knowledge to extract useful features from stored data, and to refine the features through trial and error by training corresponding models and observing their relative performance. In view of the inordinate time and expense of manual feature selection, automated feature selection systems have been proposed to perform portions of the feature engineering process using, for example, a search framework, a correlation model, or a Large Language Model (LLM).

These existing manual and automated feature selection systems attempt to generate features which are statistically important to the desired output of the algorithm. However, these methods fail to reliably generate features which are interpretable by domain experts. Interpretability of the input features enhances the interpretability of the resulting ML algorithms. Moreover, input features which are interpretable by domain experts increase a level of trust associated with the output of the ML algorithms. Improved automation of the feature engineering process to efficiently generate effective and interpretable input features is desired.

### BRIEF DESCRIPTION OF THE DRAWINGS

FIG. 1 is a block diagram of an architecture to generate interpretable and statistically-important features according to some embodiments.

FIGS. 2A and 2B comprise a flow diagram of a process to generate interpretable and statistically-important features according to some embodiments.

FIG. 3 illustrates a prompt template according to some embodiments.

FIG. 4 illustrates a prompt according to some embodiments.

FIG. 5 is a block diagram of an architecture to train a model to output a target based on a set of features and training data.

FIG. 6 is a block diagram of an architecture to determine performance of a trained model based on a set of features and test data.

FIG. 7 is an outward view of an interface presenting selected input features of a trained model according to some embodiments.

FIG. 8 illustrates a system to provide trained models to applications according to some embodiments.

FIG. 9 is a block diagram of a hardware system for providing trained models according to some embodiments.

### DETAILED DESCRIPTION

The following description is provided to enable any person in the art to make and use the described embodiments. Various modifications, however, will be readily-apparent to those in the art.

Some embodiments provide a scalable solution to automate feature engineering for predictive modeling that considers feature interpretability and predictive model performance. Embodiments may advantageously utilize text generation models such as LLMs to efficiently generate candidate features. Feature interpretability, as discussed herein, relates to the intellectual effort required by a domain expert to understand a feature. In other words, interpretability is inversely related to the amount of effort required to map a feature to a specific domain of interest so as to facilitate understanding of the data underlying the feature.

Embodiments may relate to a predictive problem on a tabular dataset D=(X, Y) consisting of a set of features X={x₁, . . . , xₚ}∈R^{n×p}, where n is the number of instances and p is the number of features, and a target vector Y which can be either discrete or continuous (i.e., compatible with classification or regression problems, respectively). An applicable L (e.g., Random Forest (RF) or XGboost (XGB)) accepts a training set and a validation set as input and returns predicted labels y

A feature engineering (FE) pipeline T={t₁, . . . , tₘ} is defined as a sequence of m transformations applied to X which include but are not limited to numerical transformations (e.g., +, −, ×, ÷, sqrt, log), logical operators (e.g., ∧, ∨, . . . ) and aggregation functions (e.g., min, max, avg, sum). A set of generated features from X using T is denoted as \hat{X} T. Embodiments therefore attempt to find a pipeline T that generates interpretable features \hat{X} T which maximize the performance E (L (\hat{X}_{T}, Y)) for a given ML algorithm L and a cross-validation performance measure E (e.g., F1-score), e.g.:

$$T = {arg}_{T} max E ( L ( {\hat{X}}_{T} , Y ) )$$

According to some embodiments, an input dataset consisting of features is acquired and reasoning tasks are applied thereto to determine external knowledge which is relevant to the input dataset. The external knowledge and the input dataset are used to populate a prompt template which includes a request to generate code. The prompt is input to several text generation models in parallel and code is output by each model. The code is executed to generate additional features based on the features of the input dataset.

A reasoning algorithm is applied to the additional features to identify and discard non-interpretable features. A model is trained based on the original features and the remaining additional features, and the remaining additional features are kept if the model shows improved performance with respect to a prior iteration. The process repeats to generate additional features and to evaluate their interpretability and performance improvement.

Embodiments may therefore synergize the robustness and creativity of text generation models with domain-specific knowledge and reasoning capabilities to produce statistically-useful and interpretable features.

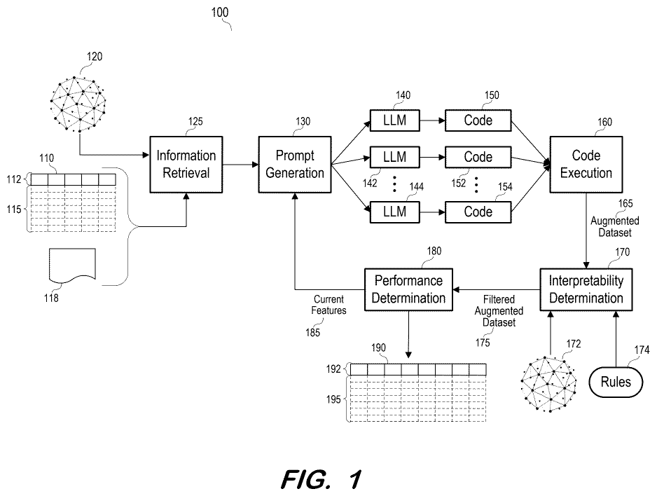

FIG. 1 is a block diagram of system 100 to generate interpretable and statistically-useful features according to some embodiments. All components illustrated herein may be implemented using any suitable combination of computing hardware and/or software that is or becomes known. In some embodiments, two or more components are implemented by a single computing device or may be co-located. One or more components may be implemented as a cloud service (e.g., Software-as-a-Service, Platform-as-a-Service). A cloud-based implementation of any components may apportion computing resources elastically according to demand, need, price, and/or any other metric.

Dataset 110 may comprise any set of data values that is or becomes known. Dataset 110 includes five columns of data 115, where each column includes data values corresponding to one of five features 112. According to some embodiments, features 112 are referred to as “raw” features because the data values associated therewith are the original values of dataset 110 which are input to system 100. As will be described below, other features may be generated based on one or more raw features. The data values associated with such other features are not natively stored in dataset 110 but are instead generated from the native data values.

Features 112 are input to information retrieval component 125. For example, text names associated with each feature 112 are input to information retrieval component 125. The text names may be identical to the column names of the columns of table 110 associated with each feature 112. According to some embodiments, text description 118 of dataset 110 is also input to information retrieval component 125 along with features 112. Text description 118 may describe the task to be performed using the features generated by system 100.

Information retrieval component 125 determines context information based on features 112, text description 118 and knowledge base 120. Knowledge base 120 may include structured knowledge such as ontologies and knowledge graphs and unstructured knowledge such as from texts and documents. For example, component 125 may identify target features of dataset 110 and maps those feature to entities within knowledge base 120. Component 125 then employs logical reasoning techniques on these entities to derive domain-specific relationships and concepts from knowledge base 120.

Prompt generation component 130 populates a prompt template with features 112, the domain-specific relationships and concepts derived from knowledge base 120, and text description 118. The prompt template includes instructions to generate code which is executable to generate additional features, and may also include instructions to generate code which is executable to drop existing features. Prompt generation component 130 inputs the populated prompt template to a plurality of text generation models such as LLMs 140, 142 and 144. LLMs 140, 142 and 144 may differ from one another in terms of architecture, weights, and/or other characteristics. The populated prompt template may be input to any number of text generation models per iteration according to some embodiments.

A text generation model as described herein may comprise a neural network trained to generate text based on input text. A text generation model may be trained based on public and/or private data. A text generation model may be implemented by, for example, executable program code, a set of hyperparameters defining a model structure and a set of corresponding weights, or any other representation of an input-to-output mapping which was learned as a result of the training. According to some embodiments, a text generation model is an LLM conforming to a transformer architecture. A transformer architecture may include, for example, embedding layers, feedforward layers, recurrent layers, and attention layers. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of text generation models include GPT-3.5-turbo, GPT-4, LaMDA, Claude and the like. A text generation model used in system 100 may be publicly available or deployed within a landscape which is trusted by a provider of system 100.

LLMs 140, 142 and 144 produce respective code 150, 152 and 154 in response to the populated prompt template. Each of code 150, 152 and 154 may comprise Python code, for example, and may differ from one another. According to some embodiments, LLMs 140, 142 and 144 also output explanations of the utility of each additional feature for which code is produced.

Code execution component 160 executes code 150, 152 and 154 on current dataset 110 to result in an augmented dataset including one or more additional features and their respective values. The augmented data set might omit or more dropped features of current dataset 110.

Interpretability determination component 170 applies a reasoning algorithm to the augmented dataset to filter out non-interpretable features therefrom. This algorithm may ensure the interpretability of the generated features and reduce factual inaccuracies and hallucinations exhibited by LLMs 140, 142, 144. According to some embodiments, entities of knowledge graph 172 and a set of Semantic Web Rule Language (SWRL) rules 174 are used to define a Description Logics (DL) class called non-interpretable. For example, a rule 174 may state that adding two features with different units results in a non-interpretable feature, and another rule 174 may specify that periodic inventory totals are not summable. Three other example rules 174 are shown below.

```
  Feature(?x) ∧ hasUnit(?x, ?u) ∧ Feature(?y) ∧ hasUnit(?y, ?v) ∧
  Different(?u, ?v)∧
Feature(?z) ∧ Addition(?f) ∧ hasInput(?f, ?x) ∧ hasInput(?f, ?y) ∧
hasOutput(?f, ?z)
→ nonInterpretable(?z)
  aggregationSum(?f) ∧ Stock(?x) ∧ Feature(?z) ∧ hasInput(?f, ?x) ∧
  hasOutput(?f, ?z)
→ nonInterpretable(?z)
  Addition(?f) ∧ Temperature(?x) ∧ Feature(?z) ∧ hasInput(?f, ?x) ∧
  hasOutput(?f, ?z)
→ nonInterpretable(?z)
```

The reasoning algorithm then determines whether each additional feature x′∈D′ can be subsumed from the concept non-interpretable, i.e., KG|=x′⊏non-interpretable. If so, the feature x′ is removed from the augmented dataset. If a feature cannot be subsumed from the concept non-interpretable but the units of the feature are unknown, the feature is also removed from the augmented dataset. All other features are considered interpretable and maintained. This approach may ensure that the additional non-discarded features and their transformations are understandable to domain experts, which enhances their trust in the model's outcomes and also helps reduce bias.

Performance determination component 180 receives the thusly-filtered augmented dataset including current dataset D and its extension dataset of additional non-discarded features D′. Component 180 splits D and D′ into training and validation sets, respectively designated as Dₜᵣₐᵢₙ, D_{valid}, D′ₜᵣₐᵢₙ and D′_{valid}. An ML algorithm, L, is then trained on D′ₜᵣₐᵢₙ and validated on D′_{valid} to obtain its performance E′. If E′ exceeds the performance E obtained in a previous iteration using Drain and D_{valid}, the new features of D′ are retained (i.e., current dataset=D+D′) and Dₜᵣₐᵢₙ and D_{valid} are updated to include D′ₜᵣₐᵢₙ and D′_{valid}. Otherwise, the new features are rejected and Dₜᵣₐᵢₙ and D_{valid} remain unchanged.

If pre-defined stopping criteria are not yet satisfied, the now-current dataset D is fed back into prompt generation component 130 to populate the prompt template and the process continues as described above. The pre-defined stopping criteria may specify a maximum number of iterations, a maximum number of additional features, a minimum performance threshold, and/or the like. If the pre-defined stopping criteria are satisfied, the now-current dataset D is output as dataset 190 comprising features 192 and corresponding instance values 195. In some embodiments, a last-trained model (i.e., trained based on features 192) is also output and may be deployed for subsequent inferences.

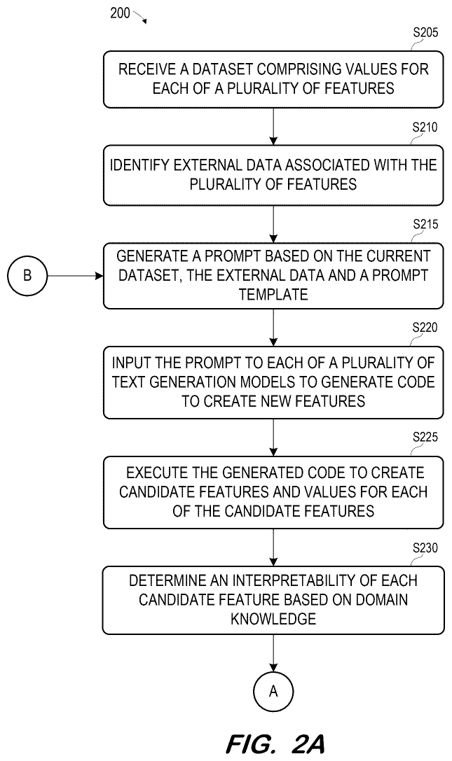

FIGS. 2A and 2B comprise a flow diagram of process 200 to generate interpretable and statistically-important features according to some embodiments. Process 200 and the other processes described herein may be performed using any suitable combination of hardware and software. Software program code embodying these processes may be stored by any non-transitory tangible medium, including a fixed disk, a volatile or non-volatile random-access memory, a DVD, a Flash drive, or a magnetic tape, and executed by any one or more processing units, including but not limited to a microprocessor, a microprocessor core, and a microprocessor thread. Embodiments are not limited to the examples described below.

Initially, a dataset including values for each of a plurality of features is received at S205. The dataset may comprise a database table in which each column represents a feature and each row comprises a value for each feature. Also received at S205 may be a description of the dataset, a description of a task to be performed using the dataset, or the like. According to the present example, the dataset may comprise describe taxi trips within New York City and the description may comprise “Problem Statement: Predict the estimated time a taxi takes to reach the entered location in New York City from the given data.”

Next, external data associated with the plurality of features is identified at S210. The external data may be determined based on the features of the dataset, the description and a knowledge base 120. Continuing the above example, the determined external data includes weather data collected from New York City during the time period represented by the received dataset.

A prompt is generated at S215 based on the current dataset, the external data and a prompt template. The prompt includes instructions to propose meaningful features for a prediction task, to justify their interpretability, and to drop unnecessary features. Also included are instructions to provide Python code to automatically generate and drop these features.

According to some embodiments, the prompt includes a general description of the dataset and the prediction task provided by the user, feature names and their context, feature data types (e.g., float, int, category), summary statistics (e.g., percentage of missing values, minimum, maximum, unique values count), and a number of random records of the dataset. The summary statistics, for example, are calculated from the dataset and included during generation of the prompt. The prompt also includes additional context information (i.e., external data) determined from external sources at S210. If external data is not available to the user, the prompt may include an instruction to suggest potential data sources to assist users in generating the necessary features.

In some embodiments, the prompt describes feature engineering, feature selection tasks, and examples of transformations for generating or removing features. The prompt also may provide a template for the required output using Chain-of-Thought (CoT) prompting which presents intermediate reasoning steps. The template may require, for each proposed feature: a name and description; an explanation of the feature's utility and interpretability; names and samples of the features used to determine the feature, and Python code to generate or drop the feature.

It is expected that the execution of code generated based on a prompt template as described herein may raise exceptions. Accordingly, the prompt template may include a placeholder for such exceptions, with corresponding instructions to resolve the exceptions.

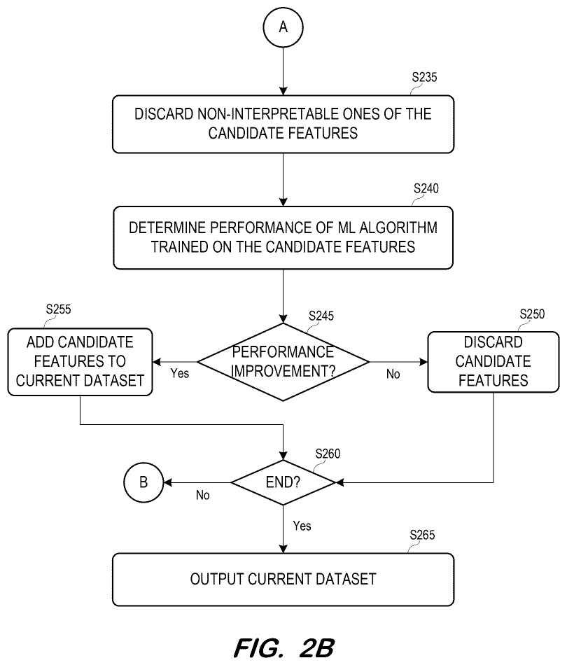

FIG. 3 illustrates prompt template 300 which may be used at S215 according to some embodiments. Prompt template 300 is a Python function that takes the dataset, its description and an external knowledge base, if available, as input, extracts relevant information (e.g., feature names, target variable, summary statistics) from the dataset, fills in the placeholders denoted by { . . . }, and returns a prompt usable to generate features. Embodiments are not limited to prompt template 300.

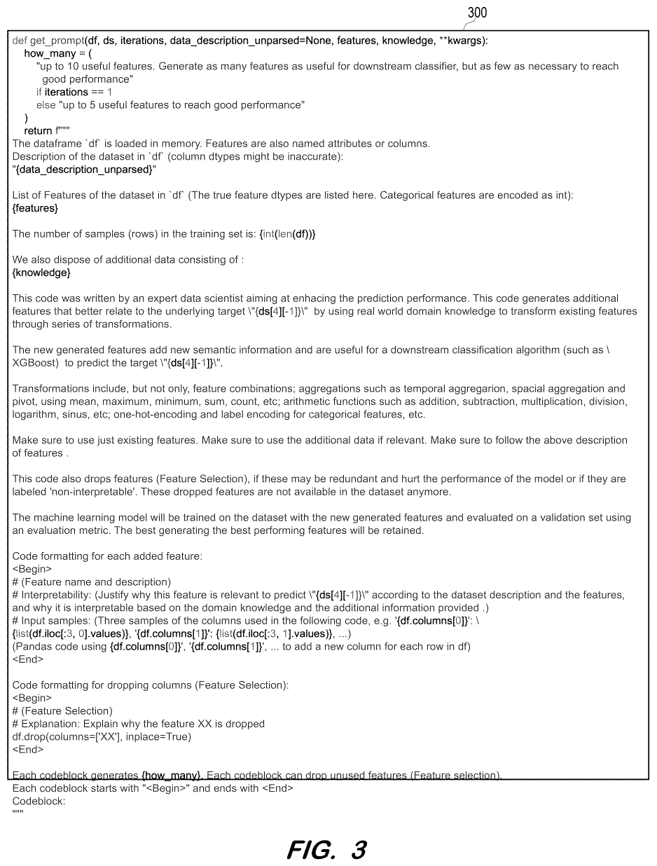

FIG. 4 illustrates prompt 400 generated at S215 according to some embodiments. Prompt 400 includes the prompt text of prompt template 300, populated with a description of the dataset, a list of features of the dataset, statistics of the listed features, additional external data identified at S210, and the variable feature.

At S220, the prompt is input to each of a plurality of text generation models. In response, each model generates code to create (and/or drop) one or more features. With respect to the present example, the code output by a model may be as follows:

# Feature: distance
# Interpretability: The distance between pickup and dropoff location can greatly affect the
duration of the trip.
# Input Samples: ‘pickup_longitude’: [−73.98215, −73.98042, −73.99403], ‘pickup_latitude’:
[40.76794, 40.73856, 40.72939], ‘dropoff_longitude’: [−73.96463, −73.99948, −74.00533],
‘dropoff_latitude’: [40.76560, 40.73115, 40.71008]
df[‘distance’] = ((df[‘pickup_longitude’] − df[‘dropoff_longitude’])**2 +
(df[‘pickup_latitude’] − df[‘dropoff_latitude′])**2)**0.5

In another example, generated code output by a model to drop a column may be as follows:

# Feature: ‘foreign_worker’
# Interpretability: This feature is dropped because it has a very low mean
{0.035}, indicating that the vast majority of samples are not foreign
workers. Therefore, this feature is unlikely to be useful for the
classification task.
df.drop(columns=[‘foreign_worker’], inplace=True)

The code generated by all the models is then executed on the current dataset at S225 to create candidate features and determine instance values for each candidate feature. Execution of the code may also result in dropping one or more features from the current dataset.

A reasoning algorithm is applied at S230 to determine an interpretability of each candidate feature. The reasoning algorithm exploits existing domain knowledge and identifies candidate features which are non-interpretable. At S235, any candidate features which are identified as non-interpretable (and their instance values) are discarded.

An ML algorithm is trained on the remaining (i.e., non-discarded) candidate features and the performance of the trained ML algorithm is evaluated at S240. Any ML algorithm suitable for the desired predictive task may be employed at S240. The ML algorithm may be trained based only on the remaining candidate features and their instances values, on an entire augmented dataset consisting of the current dataset and the instance values of the candidate features, or on a combination thereof. Evaluation of the performance may include determination of any one or more performance indicators.

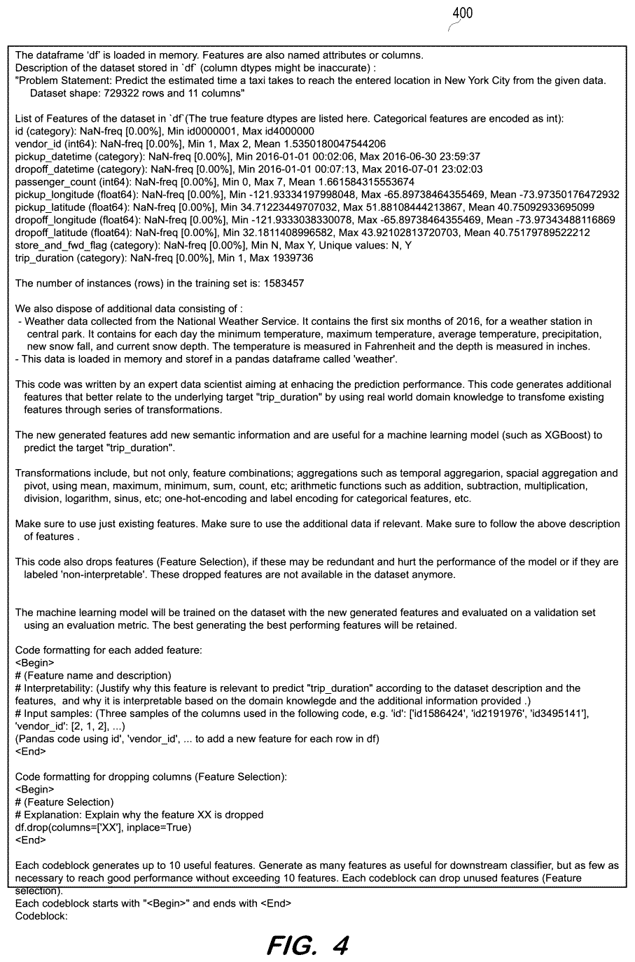

FIG. 5 illustrates training architecture 500 which may be used to train an ML algorithm at S240 in some embodiments. Model 530 may comprise a regression model implemented using a neural network, a set of linear equations, or in any other suitable manner to determine a target feature value based on a set of input features. Columns 510 include training data, where each of columns 510 includes values corresponding to one of the candidate features. Column 520 includes a ground truth value of the target feature for each row of columns 510.

One training iteration according to some embodiments may include inputting a batch of records of columns 510 to model 530, operating model 530 to output resulting inferred values 540 for each record, operating loss layer 550 to evaluate a loss function based on output inferred values 540 and known ground truth data of column 520 and modifying model 530 based on the evaluation. Iterations may continue until a threshold number of iterations have been performed, for example.

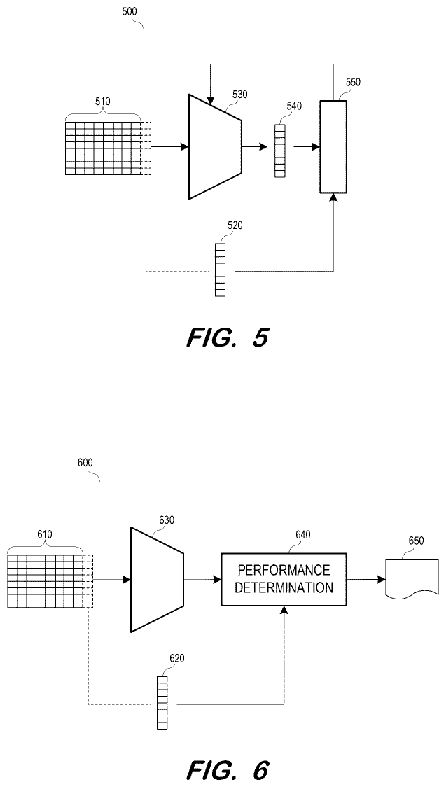

FIG. 6 illustrates system 600 to determine performance of a trained network according to some embodiments of S240. Columns 610 include test data associated with the same features represented by columns 510 of training data. Column 620 includes ground truth data values associated with each row of columns 610.

Trained model 630 receives records of columns 610 and outputs an inferred value for each record to performance determination component 640. Performance determination component 640 compares the received values to corresponding values of column 620 to determine one or more performance metrics 650 (e.g., accuracy, precision, recall). Performance metrics 650 serve as a proxy for the statistical performance of the candidate features.

At S245, it is determined whether the performance has improved with respect to a performance determined during a prior iteration of process 200. During a first iteration of S245, the performance may be compared to a performance of the ML algorithm as trained on the original dataset. If the performance has not improved, the candidate features are discarded at S250. If, on the other hand, the performance has improved, the candidate features are added to the current dataset at S255.

To improve efficiencies, S240 through S255 may be executed independently for various batches of candidate features according to some embodiments. For example, assuming that six non-discarded candidate features result from S235, three of the candidate features and the current dataset are used to train an ML algorithm and the performance of the trained algorithm is determined at S240. All three candidate features are discarded at S250 if the determination at S245 is negative and all three candidate features are added to the current dataset at S255 if the determination at S245 is positive. Next, the remaining three candidate features and the current dataset are used to train an ML algorithm and the performance of the trained algorithm is determined at S240. These three candidate features are discarded at S250 if the determination at S245 is negative and are added to the current dataset at S255 if the determination at S245 is positive.

Flow proceeds from S250 and S255 to S260. At S260, it is determined whether to stop generation of new features. As described above, the determination may be based on a predefined maximum number of iterations, a maximum number of additional features, a minimum performance threshold, and/or the like. Flow returns to S215 if the determination at S260 is negative. Upon returning to S215, the now-current dataset is used to generate a new prompt for input to the text generation models. Flow then continues as described above to generate and evaluate candidate features.

Once it is determined at S260 to stop generation of new features, flow proceeds to S265 to output the current data set. By virtue of the prior steps, the current dataset includes the original dataset minus any features of the original dataset which were dropped during the prior steps, as well as any candidate features which were not discarded at S235 and which were determined to improve performance of a trained model.

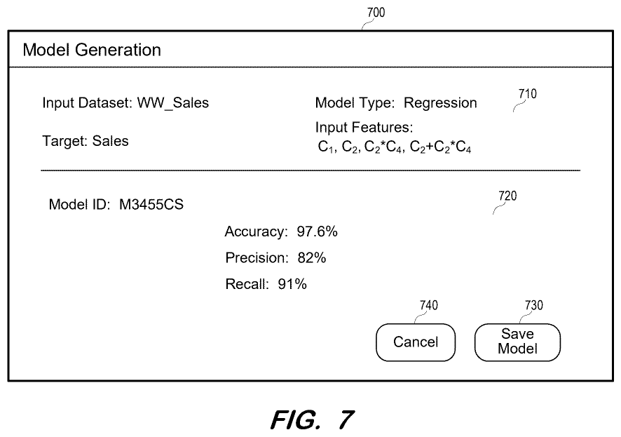

FIG. 7 illustrates interface 700 presenting information associated with a model trained using features generated according to some embodiments. User interface 700 may be presented by a user device executing a client application (e.g., a Web application) which provides definition and training of machine learning models. User interface 700 includes area 710 presenting various configuration parameters of a trained model. The configuration parameters include an input dataset (e.g., an OLAP cube), a type of model (i.e., Regression), and a training target (i.e., Sales). Area 710 also specifies a set of features which were generated as described above.

Area 720 provides information regarding a model which has been trained based on the configuration parameters of area 710. In the illustrated example, area 720 specifies an identifier of the trained model and determined accuracy, precision and recall values. Embodiments are not limited to the information of area 720. A user may review the information provided in area 720 to determine whether to save the trained model for use in generating future inferences (e.g., via Save Model control 730) or to discard the trained model (e.g., via Cancel control 740).

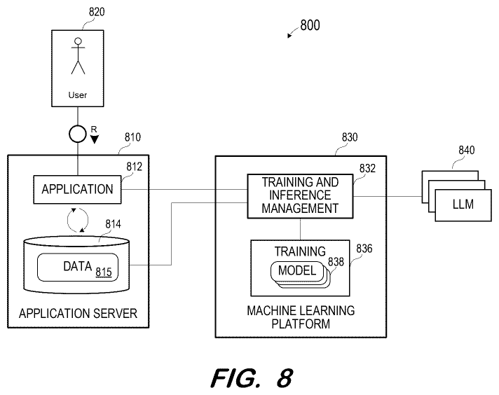

FIG. 8 illustrates system 800 to provide model training services according to some embodiments. Application server 810 may comprise an on-premise or cloud-based server providing an execution platform and services to applications such as application 812. Application 812 may comprise program code executable by a processing unit to provide functions to users such as user 820 based on logic and on data 815 stored in data store 814. Data 815 may be column-based, row-based, object data or any other type of data that is or becomes known. Data store 814 may comprise any suitable storage system such as a database system, which may be partially or fully remote from application server 810, and may be distributed as is known in the art.

According to some embodiments, user 820 may interact with application 812 (e.g., via a Web browser executing a client application associated with application 812) to request a trained model based on data of data 815. In response to the request, application 812 may call training and inference management component 832 of machine learning platform 830 to request training of a corresponding model according to some embodiments.

Based on the request, training, and inference management component 832 may receive the specified data from data 815 and execute process 200 to determine a set of features as described above. Component 832 may also instruct training component 836 to train a model 838 based on the determined set of features. Application 812 may then use the trained model to generate inferences based on input data selected by user 820.

In some embodiments, application 812 and training and inference management component 832 may comprise a single system, and/or application server 810 and machine learning platform 830 may comprise a single system. In some embodiments, machine learning platform 830 supports model training and inference for applications other than application 812 and/or application servers other than application server 810.

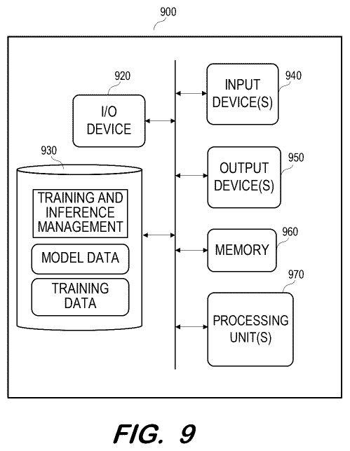

FIG. 9 is a block diagram of a hardware system providing model training according to some embodiments. Hardware system 900 may comprise a general-purpose computing apparatus and may execute program code to perform any of the functions described herein. Hardware system 900 may be implemented by a distributed cloud-based server and may comprise an implementation of machine learning platform 830 in some embodiments. Hardware system 900 may include other unshown elements according to some embodiments.

Hardware system 900 includes processing unit(s) 910 operatively coupled to I/O device 920, data storage device 930, one or more input devices 940, one or more output devices 950 and memory 960. I/O device 920 may facilitate communication with external devices, such as an external network, the cloud, or a data storage device. Input device(s) 940 may comprise, for example, a keyboard, a keypad, a mouse or other pointing device, a microphone, knob, or a switch, an infra-red (IR) port, a docking station, and/or a touch screen. Input device(s) 940 may be used, for example, to enter information into hardware system 900. Output device(s) 950 may comprise, for example, a display (e.g., a display screen) a speaker, and/or a printer.

Data storage device 930 may comprise any appropriate persistent storage device, including combinations of magnetic storage devices (e.g., magnetic tape, hard disk drives and flash memory), optical storage devices, Read Only Memory (ROM) devices, and RAM devices, while memory 960 may comprise a RAM device.

Data storage device 930 stores program code executed by processing unit(s) 910 to cause system 900 to implement any of the components and execute any one or more of the processes described herein. Embodiments are not limited to execution of these processes by a single computing device. Data storage device 930 may also store data and other program code for providing additional functionality and/or which are necessary for operation of hardware system 900, such as device drivers, operating system files, etc.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation some embodiments may include a processor to execute program code such that the computing device operates as described herein.

Embodiments described herein are solely for the purpose of illustration. Those in the art will recognize other embodiments may be practiced with modifications and alterations to that described above.

What is claimed is:

1. A system comprising:
a memory storing program code; and
at least one processing unit to execute the program code to cause the system to:
receive a dataset comprising a plurality of features;
prompt each of a plurality of text generation models to generate code to create one or more features based on the dataset;
execute the code generated by each of the plurality of text generation models on the dataset to create a first set of candidate features;
discard non-interpretable features of the first set of candidate features to create a second set of candidate features;
determine a performance of a machine learning model trained using the second set of candidate features; and
determine to add the second set of candidate features to the dataset based on the determined performance.

2. The system according to claim 1, wherein prompting of each of the plurality of text generation models comprises inputting of a first prompt to each of the plurality of text generation models.

3. The system according to claim 2, wherein the first prompt comprises includes external information associated with the plurality of features.

4. The system according to claim 3, the at least one processing unit to execute the program code to cause the system to:
determine the external information based on the plurality of features, and
wherein the first prompt includes a description of the dataset and a description of a task.

5. The system according to claim 1, wherein the generated code includes code to drop one of the plurality of features from the dataset.

6. The system according to claim 1, wherein determination to add the second set of candidate features to the dataset based on the determined performance comprises:
determination of a performance of a machine learning model trained on the dataset;
determination that the performance of the machine learning model trained using the second set of candidate features is greater than the performance of the machine learning model trained on the dataset.

7. The system according to claim 1, wherein discarding of the non-interpretable features comprises:
determination of ones of the first set of features which can be subsumed from a class defined by entities of a knowledge graph and a set of Semantic Web Rule Language rules.

8. The system according to claim 1, wherein discarding of the non-interpretable features of the first set of candidate features creates the second set of candidate features and a third set of candidate features, the at least one processing unit to execute the program code to cause the system to:
determine a second performance of a second machine learning model trained using the third set of candidate features; and
determine to discard the third set of candidate features based on the determined second performance.

9. A method comprising:
receiving a dataset comprising a plurality of features;
generating a prompt comprising instructions to generate code to create one or more features based on the dataset;
inputting the prompt to each of a plurality of text generation models;
receiving, from each of the plurality of text generation models, code to create one or more features based on the dataset;
executing the code received from each of the plurality of text generation models on the dataset to create a first set of candidate features;
determining non-interpretable features of the first set of candidate features;
discarding the non-interpretable features from the first set of candidate features to create a second set of candidate features;
determining a performance of a machine learning model trained using the second set of candidate features; and
determining to add the second set of candidate features to the dataset based on the determined performance.

10. The method according to claim 9, wherein the prompt comprises includes external information associated with the plurality of features.

11. The method according to claim 10, further comprising:
determining the external information based on the plurality of features, and
wherein the prompt includes a description of the dataset and a description of a task.

12. The method according to claim 9, wherein the generated code includes code to drop one of the plurality of features from the dataset.

13. The method according to claim 9, wherein determining to add the second set of candidate features to the dataset based on the determined performance comprises:
determining a performance of a machine learning model trained on the dataset;
determining that the performance of the machine learning model trained using the second set of candidate features is greater than the performance of the machine learning model trained on the dataset.

14. The method according to claim 9, wherein determining the non-interpretable features comprises:
determining ones of the first set of features which can be subsumed from a class defined by entities of a knowledge graph and a set of Semantic Web Rule Language rules.

15. The method according to claim 9, wherein discarding the non-interpretable features from the first set of candidate features creates the second set of candidate features and a third set of candidate features, the method further comprising:
determining a second performance of a second machine learning model trained using the third set of candidate features; and
determining to discard the third set of candidate features based on the determined second performance.

16. One or more non-transitory media storing program code executable by at least one processing unit of a computing system to cause the computing system to:
receive a dataset comprising a plurality of features;
generate a prompt comprising instructions to generate code to create one or more features based on the dataset;
input the prompt to each of a plurality of text generation models;
receive, from each of the plurality of text generation models, code to create one or more features based on the dataset;
execute the code received from each of the plurality of text generation models on the dataset to create a first set of candidate features;
determine non-interpretable features of the first set of candidate features;
discard the non-interpretable features from the first set of candidate features to create a second set of candidate features;
determine a performance of a machine learning model trained using the second set of candidate features; and
determine to add the second set of candidate features to the dataset based on the determined performance.

17. The one or more non-transitory media of claim 16, the program code executable by at least one processing unit of a computing system to cause the computing system to:
determine external information based on the plurality of features, and
wherein the prompt includes the external information, a description of the dataset and a description of a task.

18. The one or more non-transitory media of claim 16, wherein the determination to add the second set of candidate features to the dataset based on the determined performance comprises:
determination of a performance of a machine learning model trained on the dataset;
determination that the performance of the machine learning model trained using the second set of candidate features is greater than the performance of the machine learning model trained on the dataset.

19. The one or more non-transitory media of claim 16, wherein determination of the non-interpretable features comprises:
determination of ones of the first set of features which can be subsumed from a class defined by entities of a knowledge graph and a set of Semantic Web Rule Language rules.

20. The one or more non-transitory media of claim 16, wherein discarding of the non-interpretable features from the first set of candidate features creates the second set of candidate features and a third set of candidate features, the program code executable by at least one processing unit of a computing system to cause the computing system to:
determine a second performance of a second machine learning model trained using the third set of candidate features; and
determine to discard the third set of candidate features based on the determined second performance.
